(19) United States
(12) Patent Application Publication
(10) Pub. No.: US 2022/0089067 A1
(43) Pub. Date: Mar. 24, 2022

(54) ROOF CHAIR SYSTEMS FOR MOTOR VEHICLES WITH REMOVABLE ROOF PANELS

(71) Applicant: FORD GLOBAL TECHNOLOGIES, LLC, Dearborn, MI (US)

(72) Inventors: Stuart C. Salter, White Lake, MI (US); David Brian Glickman, Southfield, MI (US); Amy Lynn Marentic, Plymouth, MI (US); Paul Kenneth Dellock, Northville, MI (US); Annette Lynn Huebner, Highland, MI (US)

(21) Appl. No.: 17/026,889

(22) Filed: Sep. 21, 2020

(51) Int. Cl. B60N 2/24; B60N 2/02; B60N 2/56; B60N 3/00; B60R 9/04; B60J 7/11; B60N 3/10

(52) U.S. Cl. CPC B60N 2/24; B60N 2/0296; B60N 2/56; B60N 3/10; B60R 9/04; B60J 7/11; B60N 3/00

(57) ABSTRACT

This disclosure details exemplary roof chair systems for vehicles equipped with removable roof panels. A mounting assembly of a roof chair system may be mounted to a roof rail after removing the removable roof panels. The roof chair system may be secured to the roof rail using the same openings used to secure the removable roof panels to the roof rail. The roof chair system may include various accessory features, such as lighting, speakers, chargers, heated seats, etc., for providing an enhanced user experience. The roof chair systems may be integrated with vehicle charging and lighting systems for providing a vehicle integrated accessory system.

### TECHNICAL FIELD

This disclosure relates to roof chair systems for vehicles that include removable roof panels.

### BACKGROUND

Some motor vehicles include roof panels that can either be opened or removed from the vehicle to provide an open air riding experience. Many vehicle owners may desire to leverage the space offered by the vehicle roof when enjoying outdoor activities, such as camping and tailgating activities.

### SUMMARY

A vehicle roof chair system according to an exemplary aspect of the present disclosure includes, among other things, a mounting assembly, a seat rotatably secured to the mounting assembly, and a control module housed within the seat and configured to communicate with a vehicle control module.

In a further non-limiting embodiment of the forgoing vehicle roof chair system, the mounting assembly includes a base, a crossbeam, a swivel plate secured to the crossbeam, and a pair of stanchions that extend between the base and the crossbeam. The seat is secured to the swivel plate.

In a further non-limiting embodiment of either of the foregoing vehicle roof chair systems, the mounting assembly includes a second base and a second pair of stanchions that extend between the second base and the crossbeam.

In a further non-limiting embodiment of any of the foregoing vehicle roof chair systems, a heating element is housed within the seat.

In a further non-limiting embodiment of any of the foregoing vehicle roof chair systems, the control module is configured to activate the heating element in response to feedback from a sensor that is housed within the seat.

In a further non-limiting embodiment of any of the foregoing vehicle roof chair systems, a light source is recessed within an arm or base of the seat.

In a further non-limiting embodiment of any of the foregoing vehicle roof chair systems, the control module is configured to coordinate a lighting effect emitted by the light source with that emitted by a vehicle ambient lighting system.

In a further non-limiting embodiment of any of the foregoing vehicle roof chair systems, an inductive charger is housed within an arm of the seat.

In a further non-limiting embodiment of any of the foregoing vehicle roof chair systems, a speaker is housed within the seat.

In a further non-limiting embodiment of any of the foregoing vehicle roof chair systems, a rechargeable battery is housed within the seat.

In a further non-limiting embodiment of any of the foregoing vehicle roof chair systems, the control module is configured to communicate with the vehicle control module to start an engine for charging the rechargeable battery when a state of charge of the rechargeable battery is below a predefined charge threshold.

A vehicle according to another exemplary aspect of the present disclosure includes, among other things, a roof including a roof rail, and a roof chair system including a mounting assembly mountable to the roof rail and a seat movably mounted relative to the mounting assembly. The mounting assembly includes a base and a pin that is insertable through an opening formed in the roof rail for securing the roof chair system to the roof rail.

In a further non-limiting embodiment of the foregoing vehicle, the mounting assembly includes the base, a swivel plate, and a pair of stanchions that extend between the base and the swivel plate. The seat is secured to the swivel plate.

In a further non-limiting embodiment of either of the foregoing vehicles, the mounting assembly includes a second base and a second pair of stanchions that extend between the second base and the swivel plate.

In a further non-limiting embodiment of any of the foregoing vehicles, the mounting assembly includes a load equalizer positioned between the base and the roof rail, and a compression limiter positioned between the pin and the base.

In a further non-limiting embodiment of any of the foregoing vehicles, the opening is formed in a top surface of the roof rail, and a second opening is formed in an inner surface of the roof rail and is configured to receive a second pin of the mounting assembly.

In a further non-limiting embodiment of any of the foregoing vehicles, the roof chair system includes a first control module that is configured to communicate with a second control module of the vehicle in order to integrate functionality of the roof chair system with that of the vehicle.

In a further non-limiting embodiment of any of the foregoing vehicles, the first control module is configured to automatically communicate a startup signal to the second control module to start an engine of the vehicle for charging a rechargeable battery of the roof chair system when a state of charge of the rechargeable battery is below a predefined charge threshold.

In a further non-limiting embodiment of any of the foregoing vehicles, the roof chair system includes at least one of a light emitting diode, an illuminated cupholder, a speaker, an inductive charger, or a heating element.

In a further non-limiting embodiment of any of the foregoing vehicles, the roof includes a removable roof panel securable to the roof rail via the opening when the roof chair system is removed from the roof rail.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a perspective view of a motor vehicle equipped with removable roof panels.

FIG. 2 is a perspective view of the vehicle of FIG. 1 with the roof panels removed.

FIG. 3 illustrates an exemplary roof chair system for a vehicle.

FIG. 4 illustrates another exemplary roof chair system for a vehicle.

FIG. 5 is a rear perspective view of a mounting assembly of a roof chair system.

FIG. 6 is a rear cross-sectional view of the mounting assembly of FIG. 5.

FIG. 7 is a rear perspective view of another mounting assembly of a roof chair system.

FIG. 8 is a rear cross-sectional view of the mounting assembly of FIG. 7.

FIG. 9 schematically illustrates a plurality of accessory features of a roof chair system.

FIG. 10 is a block diagram of a control system of a roof chair system.

FIG. 11 illustrates yet another exemplary roof chair system for a vehicle.

FIG. 12 schematically illustrates an exemplary method for folding and stowing the roof chair system of FIG. 11.

### DETAILED DESCRIPTION

This disclosure details exemplary roof chair systems for vehicles that includes removable roof panels. A mounting assembly of a roof chair system may be mounted to a roof rail after removing the removable roof panels. The roof chair system may be secured to the roof rail using the same openings used to secure the removable roof panels to the roof rail. The roof chair system may include various accessory features, such as lighting, speakers, chargers, heated seats, etc., for providing an enhanced user experience. The roof chair systems may be integrated with vehicle charging and lighting systems for providing a vehicle integrated accessory system. These and other features of this disclosure are described in greater detail below.

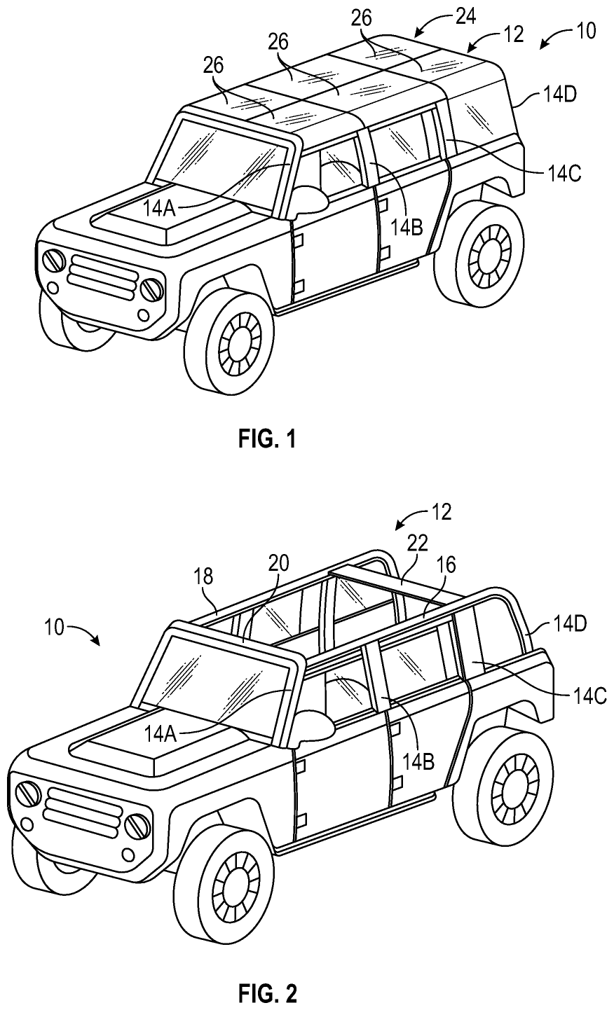

FIGS. 1 and 2 illustrate a motor vehicle 10. In an embodiment, the vehicle 10 is a sport utility vehicle (SUV). However, the vehicle 10 could alternatively be configured as a car, a truck, a van, or any other type of vehicle within the scope of this disclosure. The vehicle 10 could also be a conventional motor vehicle, a battery powered hybrid or electric vehicle, or an autonomous vehicle (i.e., a driverless vehicle).

Although a specific component relationship is illustrated in the figures of this disclosure, the illustrations are not intended to limit this disclosure. In other words, the placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component.

The vehicle 10 includes a roof 12 supported by a plurality of pillars 14. In an embodiment, the vehicle 10 is a four-door vehicle and therefore includes A-pillars 14A, which are closest the front of the vehicle 10, D-pillars 14D, which are closest to the rear of the vehicle 10, and B-pillars 14B and C-pillars 14C, which are intermediate pillars disposed between the A-pillars 14A and the D-pillars 14D. However, the teachings of this disclosure are also applicable to two-door vehicles having one door assembly located on both a driver side and a passenger side of the vehicle. Unless stated otherwise in this disclosure, the use of a given reference numeral (e.g., 14, etc.) without any alphabetic identifier immediately following the reference numeral may refer to any of the components identified by that same reference number. For example, when used alone, the reference numeral “14” may refer to any of the pillars 14A, 14B, 14C, and 14D.

The roof 12 may include a first roof rail 16 and a second roof rail 18 extending longitudinally between the front and the rear of the vehicle 10, and a third roof rail 20 and a fourth roof rail 22 extending horizontally between the first and second roof rails 16, 18. However, other roof configurations are further contemplated within this disclosure.

The roof 12 may include a removable hard-top 24 (sometimes called a “hard-top roof”). The removable hard-top 24 may include a plurality of removable roof panels 26. The roof panels 26 may be made of a rigid material, such as one or more of plastic, metal, and/or glass. Together, the roof panels 26 protect the vehicle cabin and its occupants from the outside environment. Removing the roof panels 26 exposes the vehicle passenger cabin and its occupants to the outside environment. During periods of good weather, removing the roof panels 26 can lead to increased enjoyment and an enhanced, open air riding experience for the occupants of the vehicle.

While a hard-top 24 is shown in FIG. 1, it should be understood that this disclosure extends to vehicles with a soft-top roof. Further, in the illustrated embodiment, there are six removable roof panels 26. However, this disclosure extends to vehicles having any amount of removable roof panels.

The roof panels 26 are configured to attach to the roof structure of the vehicle 10. In an embodiment, the roof panels 26 may be removably attached to one or more of the first roof rail 16, the second roof rail 18, the third roof rail 20, and the fourth roof rail 22 of the roof structure.

The vehicle owner/user may desire to leverage the space afforded by the roof 12 after removing the roof panels 26, such as when using the vehicle 10 as a social gathering spot during outdoor activities (e.g., camping, tailgating, etc.). As an example, the vehicle owner/user may desire to sit on the roof 12 when the roof panels 26 are removed. This disclosure describes roof chair systems that enable users to sit on the roof 12 and provide integrated features for enhancing the user experience during the outdoor activities.

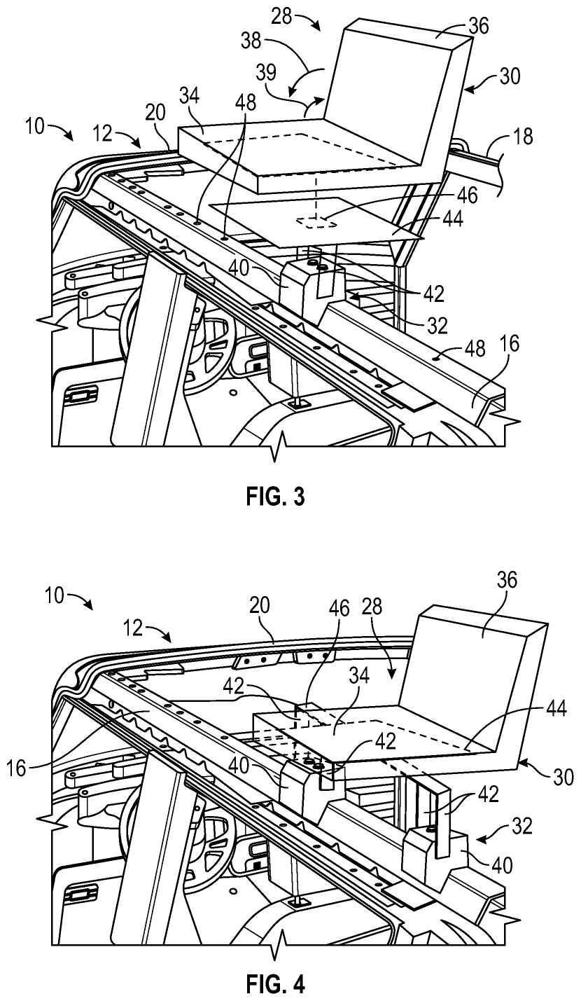

FIG. 3, with continued reference to FIGS. 1 and 2, illustrates an exemplary roof chair system 28 that can be mounted to the roof 12 after removing the roof panels 26. Although only a single roof chair system 28 is shown on the roof 12, one or more roof chair systems 28 could be mounted to the roof 12 to provide seating for multiple people. Moreover, the roof chair system 28 is shown mounted to the first roof rail 16, but this disclosure is not limited to such a configuration. The roof chair system 28 could be alternatively mounted to the second roof rail 18, the third roof rail 20, or the fourth roof rail 22. In an embodiment, at least two roof chair systems 28 may be mounted to each of the first roof rail 16 and the second roof rail 18.

The roof chair system 28 may include a seat 30 and a mounting assembly 32. The mounting assembly 32 is configured to secure the seat 30 to the roof 12, and in particular, to one of the first roof rail 16, the second roof rail 18, the third roof rail 20, or the fourth roof rail 22.

The seat 30 may include a seat base 34 and a seat backrest 36. A user may sit on the seat base 34 and position their back against the seat backrest 36. One or both of the seat base 34 and the seat backrest 36 may be cushioned. In an embodiment, the seat 30 is a foldable seat in which the seat backrest 36 may be folded in the direction of arrow 38 against the seat base 34, the seat base 34 may be folded in a direction of arrow 39 against the seat backrest 36, or both.

The mounting assembly 32 may be configured in either a single-base configuration (see FIG. 3) or a dual-base configuration (see FIG. 4). The mounting assembly 32 may therefore include one or more bases 40, two or more stanchions 42, and a swivel plate 44. Each base 40 may be secured directly to the first roof rail 16 in the illustrated embodiment. At least two stanchions 42 are secured to each base 40 and extend upwardly away from the base 40. The stanchions 42 may connect at an opposite end to either the swivel plate 44 or a crossbeam 46 that traverses the distance between adjacent stanchions 42. The swivel plate 44 may be rotatably mounted to the crossbeam 46 or the swivel plate 44. The swivel plate 44 may be mounted to the seat base 34 to configure the seat 30 to swivel relative to the mounting assembly 32.

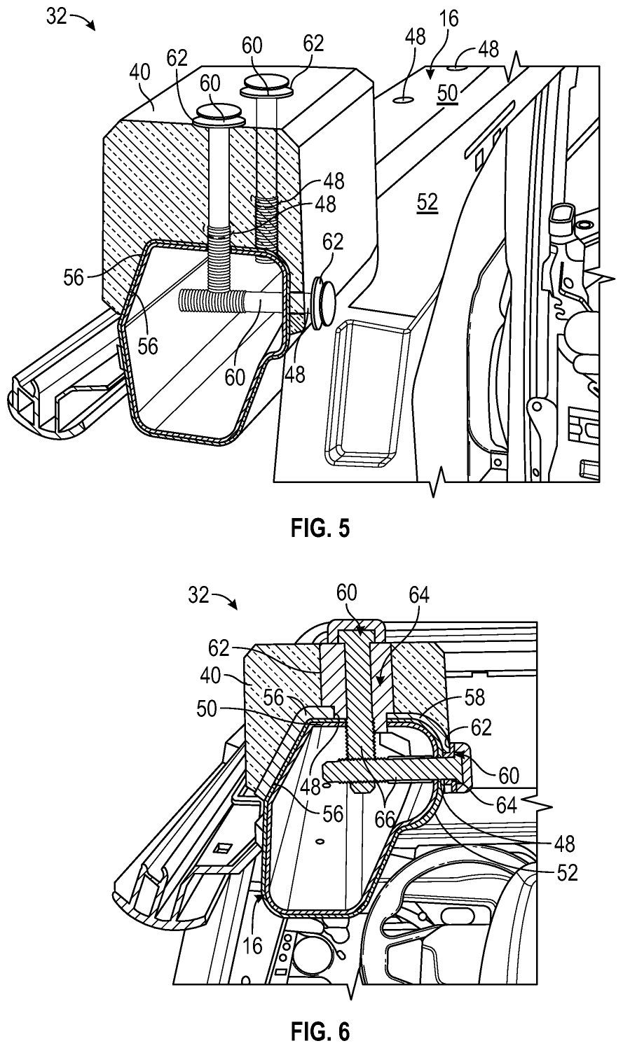

Referring now to FIGS. 5 and 6, each base 40 of the mounting assembly 32 may be secured to the roof 12 using existing openings 48 formed in the first roof rail 16 (and/or the second roof rail 18) of the roof 12. The openings 48 may be located in a top surface 50 of the first roof rail 16, an inner surface 52, or both. The inner surface 52 faces in a direction toward the interior of the vehicle 10. In an embodiment, the openings 48 are the same openings used to mount the removable roof panels 26 to the roof 12.

Each base 40 may include a recessed surface 54 that is sized and shaped to conform to a shape of portions of the first roof rail 16. Once received against the first roof rail 16, the base 40 may be received about or directly against portions of the top surface 50, the inner surface 52, and an outer surface 56 of the first roof rail 16.

A load equalizer 58 may be positioned between the recessed surface 54 of the base 40 and the first roof rail 16. In an embodiment, the load equalizer 58 is a rubber isolator. The load equalizer 58 is configured to prevent paint damage or other physical damage to the first roof rail 16 by the roof chair system 28.

A plurality of pins 60 may secure the base 40 to the first roof rail 16. The pins 60 may be inserted through openings 62 formed in the base 40 and then through the openings 48 of the first roof rail 16. In an embodiment, two pins 60 are inserted through openings 48 of the top surface 50 of the first roof rail 16, and one pin 60 is inserted through the opening 48 of the inner surface 52 of the first roof rail 16. However, the total number of fasteners utilized to secure the base 40 at both the top surface 50 and the inner surface 52 of the first roof rail 16 is not intended to limit this disclosure.

The pin 60 inserted through the inner surface 52 of the first roof rail 16 may be located in a different fore-aft plane relative to the pins 60 that are inserted through the top surface 50 of the first roof rail 16. The pins 60 therefore cannot contact one another during insertion when mounting the base 40 to the first roof rail 16.

A compression limiter 64 may be positioned between each opening 62 of the base 40 and each pin 60. The compression limiter 64 is designed to control the compressive forces generated during fixation of the pins 60, thereby ensuring joint integrity across the base-roof rail joint.

In an embodiment, each pin 60 is a spring loaded pin that includes an additional compression limiter 66 (e.g., a spring). Alternatively, a rivet nut could be used. The compression limiters 66 are designed to act as a joint support and stiffener to ensure a hard joint and produce a robust clamp load, for example.

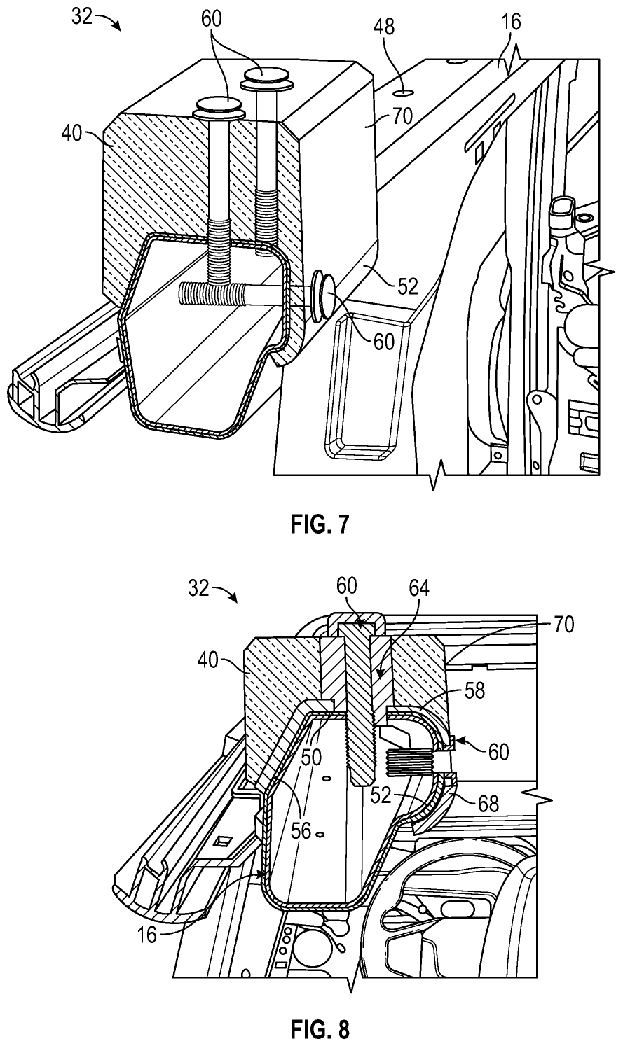

The base 40 may optionally include an integral hook 68 (see FIGS. 7 and 8). The integral hook 68 may extend from an inner-facing surface 70 of the base 40. The integral hook 68 may hook or otherwise latch to the inner surface 52 of the first roof rail 16. In an exemplary assembly method, the integral hook 68 is secured relative to the inner surface 52 of the first roof rail 16, the pin 60 is then inserted through the inner surface 70 of the base 40 and through the inner surface 52 of the first roof rail 16, and then the base 40 is rotated into position against the top surface 50 of the first roof rail 16 prior to inserting the pins 60 through the base 40 and the top surface 50.

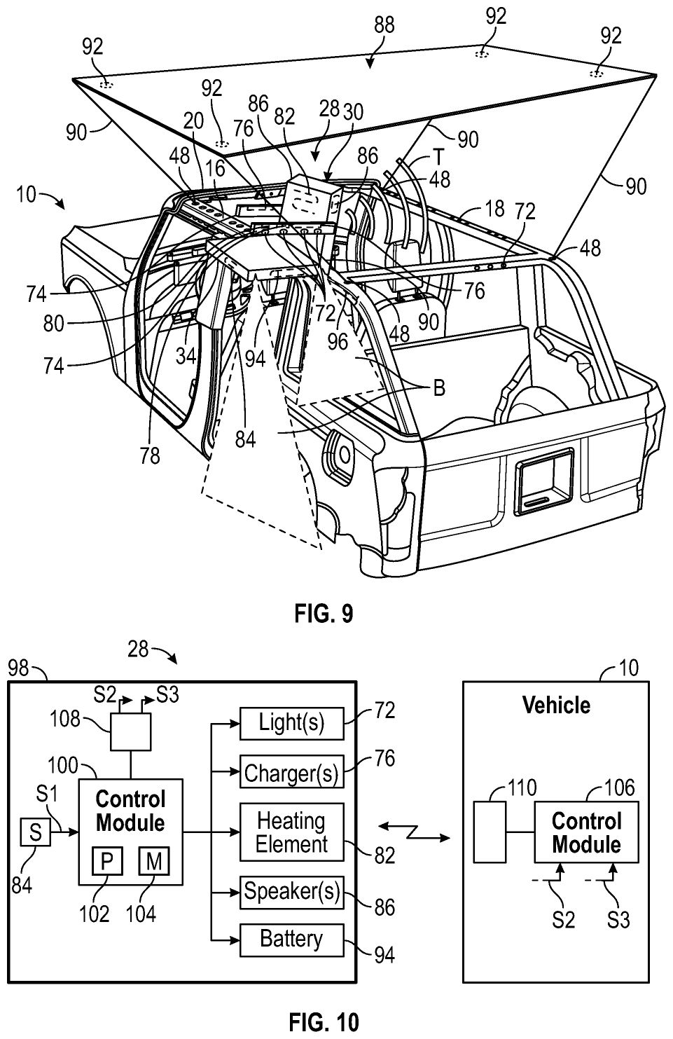

FIG. 9 illustrates a plurality of accessory features that may be included as part of the roof chair system 28. As a first exemplary accessory feature, the seat 30 of the roof chair system 28 may include one or more light sources 72 for providing functional/decorative lighting both inside and outside the vehicle 10. Each light source 72 may be a light emitting diode (LED). In an embodiment, each light source 72 is a multi-colored LED, such as a Red, Green, Blue (RGB) LED, for example. Other light sources could also be utilized within the scope of this disclosure.

The light sources 72 may be provided in the seat base 34, in one or both arms 74 of the seat 30, or within both the seat base 34 and the arms 74. In an embodiment, the light sources 72 are recessed within the seat base 34 and/or the arms 74. The light sources 72 may be recessed in a submarine configuration such that users cannot see the light sources 72 when viewing the seat 30. The submarine configuration produces a downward projecting, narrow light beam B that does not shine directly into the eyes of bystanders.

The roof chair system 28 may additionally include one or more inductive chargers 76. In an embodiment, one inductive charger 76 is provided within each arm 74 of the seat 30. Users of the roof chair system 28 may charge electronics devices, such as a cell phone, via the inductive chargers 76. A port 78, such as a universal serial bus (USB) port, may also be provided in one or both of the arms 74.

Each arm 74 of the seat 30 may also be equipped with one or more illuminated cupholders 80. The illuminated cupholders 80 are configured to receive and hold a beverage container of the user.

A heating element 82 may be disposed within the seat base 34, the seat backrest 36, or both. The heating element 82 may be selectively activated to heat a user sitting in the seat 30. A sensor 84, such as a capacitive sensor, may be housed within the seat 30 and is configured to detect when the seat 30 is occupied. The heating element 82 may automatically be turned ON when the sensor 84 detects the presence of a user in the seat 30.

The roof chair system 28 may additionally include one or more speakers 86. The speakers 86 may be configured for playing music or other audible tones T. The speakers 86 may be provided in the seat base 34, in the seat backrest 36, or both. In an embodiment, the speakers 86 are Bluetooth speakers and can thus be controlled via a personal electronic device of the user of the roof chair system 28.

A canopy 88 may be utilized in conjunction with the roof chair system 28 for providing protection from the sun, rain, or other outdoor elements. The canopy 88 may include poles 90 that can be positioned within the openings 48 formed in the top surfaces 50 of the first roof rail 16 and the second roof rail 18. The canopy 88 may include one or more light sources 92, such as LEDs, for providing additional functional/decorative lighting effects individually of or in combination with the light sources 72 of the roof chair system 28.

The roof chair system 28 may further include a rechargeable battery 94 for powering the various accessory features described above. The rechargeable battery 94 may be mounted within either the seat base 34 or the seat backrest 36 of the seat 30. In an embodiment, the rechargeable battery 94 is a lithium-ion battery. The rechargeable battery 94 may be charged by plugging the rechargeable battery 94 into a power outlet located inside the vehicle 10 or into a wiring take-out 96 mounted within the first roof rail 16.

FIG. 10, with continued reference to FIG. 9, schematically illustrates a control system 98 of the roof chair system 28. The control system 98 may include a control module 100 that is configured to control the various operations of the roof chair system 28. The control module 100 may be operably linked to the light source(s) 72, the inductive charger(s) 76, the heating element(s) 82, the sensor 84, the speaker(s) 86, and the rechargeable battery 94 for coordinating operations of these accessory devices. The control module 100 may be housed inside the seat 30 of the roof chair system 28, such as either within the seat base 34 or the seat backrest 36.

The control module 100 may be equipped with executable instructions for interfacing with and commanding operation of various components of the roof chair system 28. The control module 100 may include a processing unit 102 and non-transitory memory 104 for executing the various control strategies and modes of the roof chair system 28. The processing unit 102 can be programmed to execute one or more programs stored in the memory 104. The programs may be stored in the memory 104 as software code, for example. Each program stored in the memory 104 may include an ordered list of executable instructions for implementing logical functions associated with the roof chair system 28. The processing unit 102 can be a custom made or commercially available processor, a central processing unit (CPU), or generally any device for executing software instructions. The memory 104 can include any one or combination of volatile memory elements and/or nonvolatile memory elements.

In an embodiment, the control module 100 may control the heating element(s) 82 based on feedback from the sensor 84. For example, the sensor 84 may communicate a signal S1 to the control module 100 in response to detecting a user seated within the seat 30. In response to receiving the signal S1, the control module 100 may activate the heating element 82 for heating the seat 30.

The control module 100 of the roof chair system 28 may wirelessly communicate with a control module 106 of the vehicle 10 in order to integrate the functionality of the roof chair system 28 with that of the vehicle 10. The wireless communications between the control modules 100, 106 may be facilitated by a first wireless device 108 of the roof chair system 28 and a second wireless device 110 of the vehicle 10. In an embodiment, the first and second wireless devices 108, 110 are Bluetooth Low Energy transceiver antenna modules (BLEAMs). However, other wireless communication systems and protocols could also be employed within the scope of this disclosure.

The control module 100 may, in an embodiment, communicate with the control module 106 in order to coordinate the color and brightness of the light sources 72 with those emitted by an ambient lighting system of the vehicle 10. Coordinating the lighting effects in this manner produces a more decorative and functional lighting that enhances the user experience during outdoor social activities, such as camping and tailgating activities, for example.

The control module 100 may, in another embodiment, communicate with the control module 106 in order to coordinate the charging of the rechargeable battery 94. For example, when the state of charge of the rechargeable battery 94 falls below a first predefined charge threshold, the control module 100 may communicate a start up signal S2 to the control module 106. The control module 106 may then command the vehicle 10 to start (e.g., by pulling up the engine) in response to receiving the startup signal S2. The rechargeable battery 94 may then be charged while the engine of the vehicle 10 is running. Subsequently, when the state of charge of the rechargeable battery 94 is above a second predefined charge threshold, the control module 100 may communicate a shut-down signal S3 to the control module 106. The control module 106 may then shut down the vehicle 10 (e.g., engine not running) in response to receiving the shut-down signal S3.

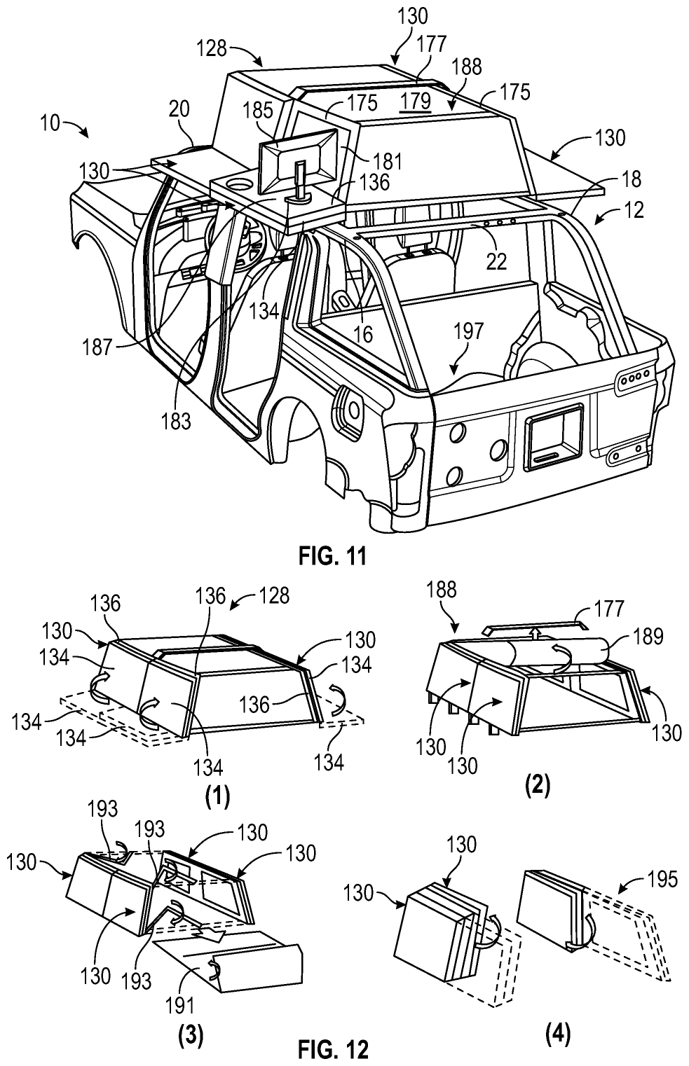

FIG. 11 illustrates another exemplary roof chair system 128 that can be mounted to the roof 12 of the vehicle 10 after removing the removable roof panels 26. In this embodiment, the roof chair system 128 includes multiple seats 130 and a canopy 188 that is integrated together with the seats 130 as a single assembly.

The roof chair system 128 may include two or more seats 130 located at each opposing side of the roof chair system 128. Each pair of seats 130 may be mounted to the first roof rail 16 or the second roof rail 18 using one or more mounting assemblies (not shown) that are similar to the mounting assemblies 32 illustrated in FIGS. 5-6 or FIGS. 7-8.

The canopy 188 is attached to and extends between the opposing sets of seats 130. In an embodiment, the canopy 188 may be secured to a framing 175 of the seats 130. A crossbar 177, which acts as a canopy stabilizer, may be secured between the opposing sets of the seats 130 at an upper surface 179 of the canopy 188.

One or more of the seats 130 may include a seat backrest 136 that is foldable relative to a seat base 134. Folding the seat backrest 136 into abutting contact with the seat base 134 may expose an access opening 181 in the canopy 188. Users may enter and exit the canopy 188 through the access opening 181. In other embodiments, the seat base 134 is foldable upwardly into abutting contact with the seat backrest 136.

The roof chair system 128 may include various accessory features, including any of the accessory features described above with reference to FIGS. 9 and 10. In an embodiment, one or more of the seats 130 may include a mounting platform 183 for mounting accessory devices 185 to the seats 130. The accessory devices 185 may include a computer, a camera, lighting, etc. The mounting platform 183 may be mounted to an inner surface 187 of the seat backrest 136 and is exposed for mounting accessories when the seat backrest 136 is folded down against the seat base 134.

FIG. 12 schematically illustrates an exemplary method for folding and stowing the roof chair system 128 of FIG. 11. First, as shown in image (1), the seat bases 134 of the seats 130 may be folded upwardly against the seat backrests 136 to a stow position. Next, as shown in image (2), the crossbar 177 and tent material 189 of the canopy 188 may be removed from the roof chair system 128. Next, as shown in image (3), a floor 191 of the canopy 188 may be removed, such as from notched grooves formed in the seats 130, and then folded. Frame members 193 of the canopy 188 may then be folded to collapse the opposing sets of seats 130 toward one another.

Finally, as shown in image (4), each set of seats 130 may be folded over one another to position the roof chair system 128 in a folded configuration 195. The folded configuration 195 may then be stowed in the vehicle 10, such as within a cargo area 197 (see FIG. 11).

The roof chair systems of this disclosure allow vehicle owners to leverage the space of the vehicle roof when enjoying outdoor activities, such as camping and tailgating activities. The exemplary roof chair systems may be secured using the same roof rail openings that are used to mount removable roof panels of the vehicle and may incorporate various accessory features, such as lighting, speakers, chargers, heated seats, etc., that enhance the user experience during outdoor activities. The roof chair systems may be integrated with vehicle charging and lighting systems for providing a vehicle integrated accessory system.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle roof chair system, comprising:
a mounting assembly;
a seat rotatably secured to the mounting assembly; and
a control module housed within the seat and configured to communicate with a vehicle control module.

2. The vehicle roof chair system as recited in claim 1, wherein the mounting assembly includes a base, a crossbeam, a swivel plate secured to the crossbeam, and a pair of stanchions that extend between the base and the crossbeam, and further wherein the seat is secured to the swivel plate.

3. The vehicle roof chair system as recited in claim 2, wherein the mounting assembly includes a second base and a second pair of stanchions that extend between the second base and the crossbeam.

4. The vehicle roof chair system as recited in claim 1, comprising a heating element housed within the seat.

5. The vehicle roof chair system as recited in claim 4, wherein the control module is configured to activate the heating element in response to feedback from a sensor that is housed within the seat.

6. The vehicle roof chair system as recited in claim 1, comprising a light source recessed within an arm or base of the seat.

7. The vehicle roof chair system as recited in claim 6, wherein the control module is configured to coordinate a lighting effect emitted by the light source with that emitted by a vehicle ambient lighting system.

8. The vehicle roof chair system as recited in claim 1, comprising an inductive charger housed within an arm of the seat.

9. The vehicle roof chair system as recited in claim 1, comprising a speaker housed within the seat.

10. The vehicle roof chair system as recited in claim 1, comprising a rechargeable battery housed within the seat.

11. The vehicle roof chair system as recited in claim 10, wherein the control module is configured to communicate with the vehicle control module to start an engine for charging the rechargeable battery when a state of charge of the rechargeable battery is below a predefined charge threshold.

12. A vehicle, comprising:
a roof including a roof rail; and
a roof chair system including a mounting assembly mountable to the roof rail and a seat movably mounted relative to the mounting assembly,
wherein the mounting assembly includes a base and a pin that is insertable through an opening formed in the roof rail for securing the roof chair system to the roof rail.

13. The vehicle as recited in claim 12, wherein the mounting assembly includes the base, a swivel plate, and a pair of stanchions that extend between the base and the swivel plate, and further wherein the seat is secured to the swivel plate.

14. The vehicle as recited in claim 13, wherein the mounting assembly includes a second base and a second pair of stanchions that extend between the second base and the swivel plate.

15. The vehicle as recited in claim 12, wherein the mounting assembly includes a load equalizer positioned between the base and the roof rail, and a compression limiter positioned between the pin and the base.

16. The vehicle as recited in claim 12, wherein the opening is formed in a top surface of the roof rail, and comprising a second opening formed in an inner surface of the roof rail and configured to receive a second pin of the mounting assembly.

17. The vehicle as recited in claim 12, wherein the roof chair system includes a first control module that is configured to communicate with a second control module of the vehicle in order to integrate functionality of the roof chair system with that of the vehicle.

18. The vehicle as recited in claim 17, wherein the first control module is configured to automatically communicate a startup signal to the second control module to start an engine of the vehicle for charging a rechargeable battery of the roof chair system when a state of charge of the rechargeable battery is below a predefined charge threshold.

19. The vehicle as recited in claim 12, wherein the roof chair system includes at least one of a light emitting diode, an illuminated cupholder, a speaker, an inductive charger, or a heating element.

20. The vehicle as recited in claim 12, wherein the roof includes a removable roof panel securable to the roof rail via the opening when the roof chair system is removed from the roof rail.
